(19) United States
(12) Patent Application Publication
(10) Pub. No.: US 2025/0276468 A1
(43) Pub. Date: Sep. 4, 2025

(54) STRAND PELLETIZER AND APPARATUS FOR FEEDING STRANDS OF PLASTIC MATERIAL TO SUCH A STRAND PELLETIZER

(71) Applicant: Maag Germany GmbH, Grossostheim (DE)

(72) Inventors: Stefan Dahlheimer, Kleinostheim (DE); Stephan Staab, Westerngrund (DE)

(21) Appl. No.: 18/984,231

(22) Filed: Dec. 17, 2024

(30) Foreign Application Priority Data
Feb. 29, 2024 (DE) 10 2024 105 749.1

(51) Int. Cl. B29B 9/06

(52) U.S. Cl. CPC B29B 9/06

(57) ABSTRACT

The present invention relates to an apparatus for feeding strands of plastic material to a strand pelletizer, having a nozzle plate for producing the strands of plastic material, which nozzle plate has a plurality of nozzle outlets distributed in a transverse direction for discharging the strands of plastic material, a preferably sloping drainage trough which can be positioned below the nozzle plate for conveying the strands of plastic material away from the nozzle plate towards the strand pelletizer, and a stripper for scraping off the nozzle plate and/or for separating the strands of plastic material discharged from the nozzle plate, wherein the stripper is successively movable in the transverse direction over the plurality of nozzle outlets and can be brought into opposite setting angles by an angle adjustment apparatus for opposite travel movements along the transverse direction.

### CROSS-REFERENCE TO RELATED APPLICATIONS

This application claims benefit under 35 USC § 119 of DE Application No. 10 2024 105 749.1 filed 29 Feb. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention generally relates to pelletizing, and more particularly to a strand pelletizer and apparatus for feeding strands of plastic material to a strand pelletizer.

### 2. Description of Related Art

In strand pelletizers or dry-cut strand pelletizers, plastic strands are usually produced by means of a continuous caster, which has a nozzle plate with a series of nozzle outlets, which are fed onto a drainage trough on which the strands of plastic material are transported away from the continuous caster side by side in order to be fed to the pelletizer and processed into cylindrical pellets. The drainage trough can be positioned under the caster with its end portion on the feed side or a feed table, which may be connected in between, and leads away from the caster at a slope, wherein a liquid cooling apparatus can be assigned to the drainage trough in order to cool down the initially still hot, viscous and possibly sticky strands of plastic material and solidify them to such an extent that they can be pelletized in the pelletizer, wherein the application of cooling liquid can also improve transport on the drainage trough, in particular in case of sticky strands of plastic material. The liquid cooling apparatuses can work with water or another cooling liquid and spray or drip it onto the drainage trough, for example, or allow a flow of cooling liquid to run down the conveyor rings in the manner of a trickle. The drainage trough can lead directly into the pelletizer, if necessary, or onto an intermediate conveyor belt, which then conveys the strands of plastic material to the pelletizer and feeds them onto its cutting blade.

The nozzle plate of the continuous caster is usually equipped with a stripper to clean the nozzle outlet openings or the outlet surface of the nozzle plate around the outlet openings by stripping or scraping off plastic residues deposited there. In particular, such a stripper can also be used to separate the strands of plastic material discharged from the nozzle plate, which is necessary, for example, during the start-up of the pelletizing process in order to conduct away strands of plastic material that are not yet suitable for pelletizing and not allow them to reach the drainage trough, but instead collect them on an inserted carrying table, for example, or allow them to fall into a water box that is kept ready. When the process is started up, the strand diameter may still be unstable, for example, or the strand temperature may still fluctuate, or contaminated strands of plastic material may still emerge, for example, if the fed material has been changed. The strippers can be used not only when starting up the process, but also when finishing a batch or interrupting the process to separate the strands of plastic material discharged from the caster and to clean the nozzle plate on the outlet side.

In principle, it is not easy to accommodate the stripper in the cramped area between the nozzle plate of the caster and the drainage trough or to design the system in such a way that the drainage trough can be moved away for the start-up process or carrying tables can be pushed in between, so that various stripper mechanisms have already been proposed.

In order not only to achieve a compact design, but also to be able to separate the strands or strip the nozzle plate sufficiently quickly, it is known to use a cutting strip as a stripper, which extends across the nozzle plate and is sufficiently long to be able to strip the nozzle outlets arranged in a row next to each other all at the same time. The cutting strip in the width of the nozzle plate is moved parallel to the nozzle plate and cuts through the emerging strands more or less simultaneously. A carrying table can be moved under the nozzle outlet or the drainage trough can be moved under the nozzle outlet at the same time as the knife bar movement in order to allow the strands to be carried along by the water and transported to the cutting head.

The cutting strip can also be positioned at a slight angle to the transverse direction along which the nozzle outlets are lined up, thus achieving a minimal time difference when cutting through the strands. However, the time offset is very small and as a result the strands enter the cutting head more or less simultaneously, which leads to a sudden resistance. The cutting strip also tends to “bounce” on the nozzle plate surface during the aforementioned wiping process, which means that an actually clean nozzle plate surface cannot be achieved. The bouncing effect also goes hand in hand with the rapid scraping movement of the cutting strip, which is necessary to prevent the melt from touching the back of the blade and sticking there in an uncontrolled manner. In order to be able to carry out this movement quickly, the knife is usually guided in templates on the left and right of the continuous caster and can be moved back and forth by a pneumatic cylinder. Due to the relatively long length of the cutting strips and their guidance only at the end portions, the tendency to bounce on the nozzle plate is increased even further.

Another problem arises from the fact that the cutting strip is stuck together with melt, at least in sections, after a stripping process. Cleaning is relatively difficult as the area between the caster and the drainage trough is relatively cramped. However, if the melt is not removed manually, it will solidify and impair the next scraping process.

The aforementioned guiding of the cutting strip on the right and left directly on the caster involves the relatively long, unsupported span of the cutting strip, but has the advantage that the adjustment of the guide templates is quite simple and remains constant, which means that the cutting strip can be positioned quite precisely to the nozzle plate exit surface.

On the other hand, it has also been proposed to attach the stripper to the approach table or the drainage trough, whereby templates can then be provided on the caster to guide the stripper movement relative to the nozzle plate surface. Such strippers attached to the feed table or the drainage trough are shown, for example, in EP 0 079 609 A1 and U.S. Pat. No. 4,528,157.

However, the disadvantage of such strippers attached to the approach table or the drainage trough is their sensitivity to changes in position between the approach table and the caster. The alignment of the drainage trough or the approach table relative to the caster has a detrimental effect on the scraping result, with even minor thermal expansion effects causing fluctuations in the relative position that impair the scraping result.

In order to avoid the sudden increase in load on the cutting blades of the pelletizer, which occurs when more or less all the cut strands of plastic material are fed onto the blades at the same time during start-up, and also the problem of the cutting strip bouncing on the die plate surface described above, it has already been suggested that the stripper be guided over the nozzle plate in the transverse direction in which the nozzle outlets are lined up next to each other, so that the strands of plastic material emerging from the nozzle outlets are not all cut off at the same time, but one after the other and thus gradually, so to speak. A stripper guided in this way in the transverse direction over the nozzle plate can have a significantly smaller length or width, which substantially only needs to be a little larger than the nozzle outlet diameter or can have a certain oversize for this purpose in order to be able to scrape the surrounding edges around the nozzle outlets.

Such transversely movable strippers are already known in various designs. For example, they can be attached to a draining chute, for example in the form of a water box, which can be pushed under the caster together with the knife so that the strands separated by the stripper can be transported past the drainage trough into a waste container.

When the system starts up, the discharge chute is moved to the side, releasing strand by strand onto the start-up table or the drainage trough so that the strands can then gradually enter the cutting head of the pelletizer. This enables the pelletizer to be started up with only a slight load increase.

On the other hand, the distance between the discharge chute and the nozzle outlet is very narrow, which can often lead to blockages that require time-consuming cleaning. An additional problem arises due to the arrangement of the guide for the discharge chute or the scraper blade attached to it in an area where rising vapors from the melt and vaporized coolant pass by. The guide is therefore often stiff and the system tends to block, making regular maintenance and cleaning necessary. Overall, the cleaning of the nozzle plate in such designs has so far also been in need of improvement.

Strippers that can be moved in a transverse direction are also used in systems that have a transversely movable approach table with a water box. The stripper can be attached to the carrying table with the water box, wherein the carrying unit can be attached to a linear guide on the machine frame and pushed under the caster from one side. When the unit is moved out of the side of the machine, the strands fall vertically downwards into a waste container. For start-up, the unit is moved under the caster, whereby the strands gradually fall onto the start-up table and are transported by the water to the cutting head or onto the drainage trough.

The scraper blade attached to the approach table can be pressed on by springs to compensate for misalignment between the caster and the approach table, although the quality of nozzle plate cleaning can also be improved here.

In any case, approach tables that can be extended in a transverse direction are very complex and require a lot of space. In the area of the caster, this makes the machine twice as wide or requires twice as much installation space in width as a conventional machine. Massive guides are also required, as the water tank must be picked up and moved in addition to the blade. Overall, this not only makes it difficult to set up the machine and the required installation space, but also to transport the machine.

Proceeding therefrom, it is the object of the present invention to provide an improved strand pelletizer and an improved apparatus for feeding strands of plastic material to such a strand pelletizer, which avoid the disadvantages of the prior art and further develop the latter in an advantageous manner. In particular, the aim is to create an effectively cleaning stripper with a compact design that is insensitive to positioning tolerances of the drainage trough and enables a stable start-up of the system without load jumps on the pelletizer.

### BRIEF SUMMARY OF THE INVENTION

In an exemplary embodiment, the present invention is an apparatus for feeding strands of plastic material to a strand pelletizer, having a nozzle plate for producing the strands of plastic material, which has a plurality of nozzle outlets, distributed in a transverse direction, for discharging the strands of plastic material, and a preferably sloping drainage trough, which can be positioned below the nozzle plate, for conveying the strands of plastic material from the nozzle plate to the strand pelletizer, and a stripper for scraping off the nozzle plate and/or for separating the strands of plastic material emerging from the nozzle plate.

According to the invention, the task is solved by an apparatus for feeding strands of plastic material to a strand pelletizer, having a nozzle plate for producing the strands of plastic material, which nozzle plate has a plurality of nozzle outlets distributed in a transverse direction for discharging the strands of plastic material, as well as a preferably sloping drainage trough, which can be positioned below the nozzle plate, for conveying the strands of plastic material away from the nozzle plate towards the strand pelletizer, and a stripper for scraping off the nozzle plate and/or for separating the strands of plastic material discharged from the nozzle plate, characterized in that the stripper is successively movable in the transverse direction over the plurality of nozzle outlets and can be brought into opposite setting angles by an angle adjustment apparatus for opposite travel movements along the transverse direction.

It is therefore proposed not to move the stripper over all nozzle outlets of the nozzle plate at the same time, but to guide it over the nozzle outlets one after the other in a transverse direction, inclining the stripper at an acute angle to the nozzle plate outlet surface in accordance with the direction of movement. According to the invention, the stripper can be guided one after the other over the several nozzle outlets in the transverse direction, in which the nozzle outlets are lined up next to one another, and can be brought to opposite setting angles by an angle adjustment apparatus for opposite travel movements along the transverse direction. If the stripper moves from left to right across the nozzle plate, it is inclined differently than if it moves from right to left across the nozzle plate.

By stripping the nozzle plate in the transverse direction, not only can the impact or shock load on the stripper and thus its tendency to jump over the nozzle plate be reduced, but the strands of plastic material are also gradually cut off and accordingly gradually fed onto the drainage trough, so that not all strands of plastic material arrive at the cutting knives of the strand pelletizer at the same time during the start-up process, but only gradually, and accordingly a load jump on the strand pelletizer can be avoided. This enables the strand pelletizer to be started up gently and carefully with only a slight increase in power.

At the same time, a high cleaning effect is achieved due to the inclined position of the stripper in relation to the nozzle plate, which is adapted to the direction of travel.

In particular, the stripper can be positioned at an angle to the nozzle plate like a hand-guided spatula when the stripper is moved over the nozzle plate. An acute angle can be set between the leading edge of the stripper and the nozzle plate and an obtuse angle between the trailing edge of the stripper and the nozzle plate, so that the spatula or the stripper can be pulled over the nozzle plate with a snug fit and without a tendency to jump, even at higher contact pressure.

The stripper can be configured in the form of a blade plate or in the form of a panel-shaped spatula and/or in the form of a substantially flat strip, although the stripper can also have a slight curvature, for example in the form of a taper that tapers towards the engagement edge. Irrespective of this, the stripper can have a substantially constant cross-section or contour across its width, for example in the form of an extruded profile, although the stripper can also be configured in the form of a simple stripper plate, which can be tapered or not tapered at the engagement edge, whereby in the latter case two engagement edges can be provided, which become active depending on the direction of movement and setting angle.

The stripper can have a straight engaging or working edge, which can also lie in a line on the nozzle plate surface when the stripper is positioned at an acute angle, whereby the stripper can be arranged with the engaging or working edge perpendicular to the direction of movement, i.e., the preferably plate-shaped stripper is not guided over the nozzle plate in the manner of an inclined snow plow, but in a frontal alignment, albeit in the direction of movement. This means that the preferably plate-shaped stripper is not guided over the nozzle plate in the manner of an inclined snow plow, but runs over the nozzle plate in a frontal orientation, albeit with the aforementioned acute setting angle on the leading stripper edge.

The stripper can advantageously be movably guided on the caster by a stripper guide or the stripper guide can be attached to the continuous caster. This allows the stripper to be guided exactly relative to the nozzle plate surface and is insensitive to positioning tolerances of the drainage trough or any approach table or discharge chute used, which can also be dispensed with completely to save space.

In particular, the stripper guide can be attached directly to the continuous caster, for example to a casting head which has the nozzle plate on the outlet side.

Irrespective of this, the stripper guide can have a carriage guide or guide profiles along which the stripper can be moved in the transverse direction, whereby the carriage guide or the guide profiles can advantageously be arranged on a side of the caster which can face away from or be different from the nozzle plate side or its outlet side. In particular, the one or more guide profiles can be arranged behind a bottom wall and/or on a caster side facing away from the direction of fall of the strands of plastic material and/or facing upwards, so that plastic vapors emanating from the emerging strands or cooling liquid mist mixed with them or rising steam do not reach the guide profiles. This prevents the stripper guide from becoming dirty and ensures permanently jam-free operation even without short maintenance intervals.

The at least one or more guide profiles can extend parallel to the transverse direction along which the nozzle outlets are lined up, so that the stripper can be moved parallel to the transverse direction.

The stripper guide can have a carriage which can be moved in the transverse direction in the aforementioned manner and on which the stripper can be pivotably or rotatably mounted in order to be able to change the setting angle for forward and reverse travel. A transverse drive, for example comprising an electric motor, can be provided to move the carriage, whereby, for example, a controllable motor such as a stepper motor can be used.

In an advantageous further development of the invention, the angle adjustment apparatus for changing the setting angle of the stripper can have a pivot drive, which can have a pivot drive axis perpendicular to the direction of travel and/or parallel to the nozzle plate outlet surface, in order to be able to adjust the setting angle of the stripper relative to the nozzle plate in the desired manner or to be able to change it for forward and reverse travel.

Preferably, the pivot drive can provide an adjustable preload or drive power or an adjustable torque in order to be able to adjust the contact force of the stripper against the nozzle plate. For example, a rotary motor can be used that can swivel the stripper back and forth depending on the direction in which the stripper is to be moved over the nozzle plate. If the stripper rests on the nozzle plate, the contact force can be adjusted by changing the torque of the rotary motor.

In principle, however, it would also be conceivable to connect the stripper to a spring-loaded pivot drive or to provide a spring stage in the drive train between a rotary motor and the stripper so that the stripper automatically adjusts its setting angle as it moves over the nozzle plate and can be set at an acute angle by deflecting the spring stage. This can compensate for any slight unevenness or shape tolerances of the travel path in relation to the panel surface. It may also be possible to change the setting angle by moving the stripper beyond the nozzle plate so that the spring device can jump or move into a neutral position and the stripper can be reversed when the direction of movement is reversed and the nozzle plate is then hit.

For example, the angle adjustment apparatus may comprise a pivot cylinder, which may have a pivot axis parallel to the nozzle plate surface and perpendicular to the transverse direction in which the stripper is moved. The stripper can be mounted directly on the pivot cylinder so that a pivoting movement of the pivot cylinder leads to a change in the setting angle of the stripper.

The pivot cylinder or the pivot drive can be attached to the aforementioned carriage, which can be moved back and forth in the transverse direction by means of the aforementioned stripper guide.

To move the stripper or the carriage back and forth, a carriage drive or traversing drive can advantageously be provided, which moves the stripper via the stripper guide in the transverse direction over the nozzle plate. Such a travel drive can advantageously comprise a controllable drive motor, for example in the form of a stepper motor. Such a controllable motor can be used or configured in particular to wipe the stripper in the end positions on a possibly heated plate or a cleaning squeegee or a cleaning spatula in order to clean the stripper of impurities from the strands of plastic material.

The carriage can be arranged on a side of the caster facing away from the nozzle plate outlet surface, in particular positioned on an upward-facing side of the caster and/or facing away from the drainage trough, whereby a cantilevered support arm can be attached to the carriage, which extends over the outlet surface of the nozzle plate and holds the stripper in the area of the nozzle outlets. The cantilevered support arm can be formed by the pivot drive, for example by the pivot cylinder, by means of which the stripper can be adjusted in its setting angle to the nozzle plate and repositioned depending on the direction of movement.

In another exemplary embodiment, the present invention is an apparatus for feeding strands to a strand pelletizer comprising a nozzle plate having nozzle outlets distributed over a transverse length, an angle adjustment apparatus, and a stripper configured to, be movable across the transverse length of the nozzle outlets in successive cycles, each cycle comprising, moving in a first direction over the transverse length, and moving in a second direction over the transverse length, the second direction opposite the first direction, be brought into a first setting angle relative the nozzle plate by the angle adjustment apparatus when moving in the first direction, and be brought into a second setting angle relative the nozzle plate by the angle adjustment apparatus when moving in the second direction.

The stripper can be further configured to at least one of, scrape off the nozzle plate, or separate strands discharged from the nozzle plate.

The stripper can have a first edge and a second edge, the first setting angle is defined by the angle between the first edge of the stripper and the nozzle plate with the stripper moving in the first direction, the second setting angle is defined by the angle between the second edge of the stripper and the nozzle plate with the stripper moving in the second direction, the angle adjustment apparatus is configured to set the first setting angle to a first acute angle, and the angle adjustment apparatus is configured to set the second setting angle to a second acute angle.

In a cycle of the successive cycles, the first acute angle is the same as the second acute angle, or the first acute angle is different than the second acute angle.

In another exemplary embodiment, the present invention is an apparatus for feeding strands to a strand pelletizer comprising, a nozzle plate for producing strands of plastic material, the nozzle plate having nozzle outlets distributed over a transverse length of an outlet side of the nozzle plate, the nozzle outlets configured for the discharge of the strands of plastic material, an angle adjustment apparatus, and a stripper configured to, be movable across at least a portion of the nozzle outlets in successive cycles, each cycle comprising moving in a first direction over the transverse length and moving in a second direction over the transverse length, the second direction opposite the first direction, be brought into a first leading edge setting angle relative the outlet side of the nozzle plate by the angle adjustment apparatus when moving in the first direction, and be brought into a second leading edge setting angle relative outlet side of the nozzle plate by the angle adjustment apparatus when moving in the second direction, wherein, the angle adjustment apparatus is configured to, set the first leading edge setting angle to a first acute angle between 15° and 85°, and set the second leading edge setting angle to a second acute angle between 15° and 85°, and in a respective cycle of the successive cycles, the first acute angle is the same as the second acute angle, or the first acute angle is different than the second acute angle.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a perspective overall view of a strand pelletizing installation with a dry or wet cutting strand pelletizer, a continuous caster and an apparatus for feeding the strands of plastic material produced by the continuous caster to the strand pelletizer, according to an advantageous embodiment of the invention.

FIG. 2 is a perspective view of the nozzle plate of the continuous caster of the strand pelletizing installation of FIG. 1, wherein a stripper associated with the nozzle plate is shown in an end position on one side of the nozzle plate.

FIG. 3 is a perspective view of the nozzle plate of the continuous caster and the associated stripper in an initial position before a stripping process.

FIG. 4 is a perspective view of the stripper during a stripping travel-viewed in the product direction or according to the perspective of FIG. 4-from left to right.

FIG. 5 is a sectional side view of the nozzle plate with the stripper acting on it, showing the setting angle of the stripper to the nozzle plate.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

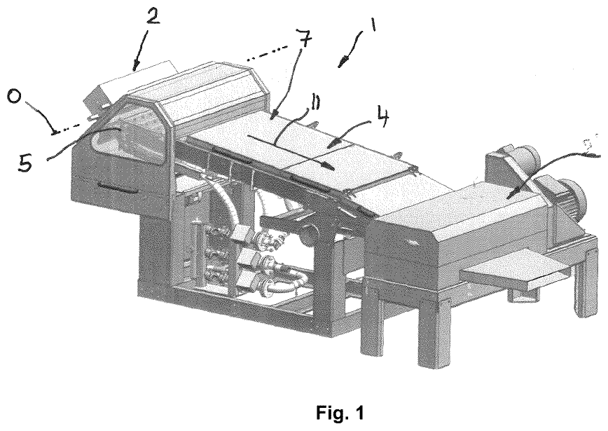

As FIG. 1 shows, a pelletizing system 1 can have a continuous caster 2 for producing hot, viscous strands of plastic material 3, which are fed from the continuous caster 2 onto a drainage trough 4. The drainage trough 4 is arranged with an end portion on the feed side, which may be formed by an extendable or movable feed or approach table 5, below the continuous caster 2 and can lead away from the continuous caster 2 at a slope in order to transport away the fed strands of plastic material lying side by side on the conveyor table 4. Instead of such a movable start-up table, however, the entire drainage trough 4 or at least an end portion of it close to the molding machine can also be swiveled for the start-up process, in particular rocked open, so that the strands of plastic material 3 do not fall onto the drainage trough 4 when the system is started up, but into a scrap trough kept ready. Such swiveling drainage troughs can be particularly advantageous if the drainage trough 4 has a rather steep operating position, which can be significantly steeper than shown in FIG. 1, as the drainage trough can then be moved quite easily out of the discharge area of the caster 2 by swiveling the drainage trough around a swivel axis arranged, for example, at the downstream end of the drainage trough, in particular a horizontal one

The drainage trough 4 can lead to a strand pelletizer 6, for example directly into the feed area of the strand pelletizer 6, in order to feed the strands of plastic material 3 to the cutting device of the strand pelletizer 6, whereby the cutting device, which is not shown separately, can for example comprise a cylindrical cutting rotor with projecting, strip-shaped cutting bars, which can interact with a stationary counter-knife. However, an intermediate conveyor may also be provided between the inclined drainage trough 4 and the strand pelletizer 6, which takes over the strands of plastic material from the downstream end of the drainage trough 4 and transports them into the strand pelletizer 6.

A liquid cooling apparatus 7 can be assigned to the drainage trough 4, which applies cooling liquid to the drainage trough 4 and/or the strands of plastic material transported thereon in order to cool the strands of plastic material and solidify them to such an extent that they can be pelletized. The liquid cooling apparatus 7 can, for example, include spray nozzles above and/or to the side of the drainage trough 4 in order to spray cooling liquid drop by drop or in the form of spray mist onto the drainage trough. Alternatively, or additionally, the entire surface of the drainage trough 4 can be filled with coolant in the manner of a trickle.

The drainage trough 4 can be provided with conveying means, for example in the form of a conveyor belt or transport rollers, but may also have a sliding bed on which the strands can slide along, at least by means of the cooling liquid.

The continuous caster 2 comprises a nozzle plate 8, the outlet side of which faces downwards in the intended operating position and/or faces the drainage trough 4 or the feed or approach table 5, so that the strands of plastic material 3 emerging from the nozzle plate 8 can be driven downwards onto the drainage trough 4 by gravity.

The nozzle plate 8 comprises at least one row of nozzle outlets 9, which may, for example, be configured in the form of through-holes passing through the nozzle plate 8, whereby the cross-section of such nozzle holes need not be constant over the length of the hole, but may be tapered or provided with a widening on the outlet side in the manner of a stemmed glass, depending on the desired material and strand properties. In general, however, cylindrical nozzle bores can also be provided as nozzle outlets 9.

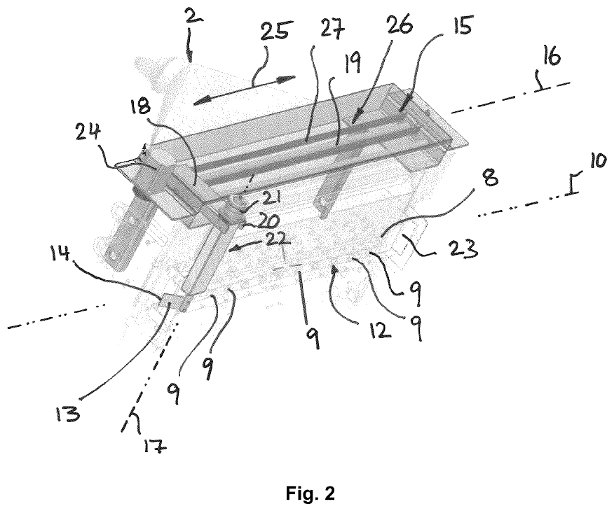

As FIGS. 2 to 4 show, the nozzle outlets 9 are arranged distributed along a transverse direction 10, extending transversely to the direction of conveyance of the drainage trough 4. The transverse direction 10 can extend horizontally and be aligned perpendicular to the conveying direction 11 of the drainage trough 4, cf. FIGS. 1 and 2.

The nozzle plate 8 can have a substantially flat configured outlet side 12 or surface on which the aforementioned nozzle outlets 9 open. This outlet side 12 looks downwards onto the drainage trough 4 or the approach table 5 and can be aligned horizontally or approximately horizontally, but may also be inclined at an angle, similar to that indicated in FIG. 2, for example at angles of inclination of 0°-45° to the horizontal or possibly steeper.

To the nozzle plate 8 there is assigned a stripper 13, which can be moved over the outlet side 12 of the nozzle plate 8 in the area of the nozzle outlets 9 in order to clean the nozzle outlets 9 and/or to separate the strands of plastic material 3 emerging therefrom.

The stripper 13 can be configured in the form of a plate-shaped spatula blade or form a panel-shaped scraper blade, cf. FIGS. 2 to 4, wherein the stripper 3 can advantageously have an at least approximately straight working edge 14, which can rest on the flat outlet surface of the nozzle plate 8.

As FIGS. 2 to 4 illustrate, the stripper 13 can be moved relative to the nozzle plate 8 along the transverse direction 10 in order to gradually sweep across the nozzle outlets 9 and gradually cut off one strand of plastic material after another.

Advantageously, the stripper 13 is mounted on the continuous caster 2 by means of a stripper guide 15, in particular attached directly thereto, the stripper guide 15 providing a translational axis of movement parallel to the transverse direction 10 for the stripper 13. In addition to the translational axis of movement 16, a rotational axis of movement 17 may be provided for the stripper 13, which may extend perpendicular to the translational axis of movement 16 and/or parallel to the outlet side 12 of the nozzle plate 8.

Advantageously, the stripper guide 15 may comprise a carriage 18 on which the stripper 13 is rotatably or pivotably mounted about the rotational axis of movement 17, the carriage 18 itself being movable along the translational axis of movement 16 relative to the nozzle plate 8.

For example, the carriage 18 can be slidably mounted on one or more guide profiles 19, for example in the form of guide rails, which can extend parallel to the transverse direction 10 and are attached to the continuous caster 2.

As the figures show, the guide profiles 19 are advantageously arranged on a caster side different from the outlet side 12 of the nozzle plate 8, in particular on a side of the continuous caster 2 which looks upwards and/or faces away from the drainage trough 4. In particular, the carriage 18 and the guide profiles 19 can be shielded from the nozzle plate 8 and/or the feed area of the drainage trough 4 by a floor or ceiling wall, so that no vapors emanating from the strands of plastic material 3 or a water vapor mixture can rise to the guide profiles 19.

As FIG. 2 illustrates, the carriage 18 or the guide profiles 19 can be located on an adjacent side of the caster 2, which is adjacent to the outlet side of the nozzle plate 8, but looks in a different direction, in particular upwards.

A cantilevered support arm 20 can be provided on the carriage 18, which can cantilever over the nozzle plate 2 and extend from the carriage 18 over the nozzle plate 8 to the area of the nozzle outlets 9 in order to support the stripper 13 there.

The support arm 20 or at least a part thereof may be formed by a pivot drive 21 which may, for example, comprise an elongate pivot cylinder which may project from the carriage 18 over the nozzle plate 8.

The pivot drive 21 can form part of an angle adjustment apparatus 22, which can be used to adjust the setting angle α of the stripper 13 relative to the nozzle plate 8, cf. FIG. 5.

The pivot drive 21 can form the aforementioned rotational axis of movement 17 of the stripper guide 15, wherein the rotational axis of movement 17 can extend from the outlet side 12 of the nozzle plate 8 parallel thereto, in particular perpendicular to the transverse direction 10.

If the pivot drive 21 is an electric motor, for example, the axis of the motor shaft can define the aforementioned rotational axis of movement 17.

As FIGS. 2 to 4 illustrate, the angle adjustment apparatus 22 can be configured to set the stripper 13 at an acute angle to the outlet side 12 of the nozzle plate 8, in particular such that a leading stripper edge is inclined at an acute angle to the outlet side of the nozzle plate 8 when the stripper 13 is moved and the trailing stripper edge is inclined at an obtuse angle thereto.

Advantageously, the leading stripper edge can be inclined to the nozzle plate 8 at an angle α, see FIG. 5, of about 15° to 85° or 25° to 75° or 35° to 75°, although other setting angles α may also be advantageous depending on the plastic to be processed. The angle adjustment apparatus 22 may comprise an automatic adjustment mode, by means of which the setting angle is automatically adjusted. However, a manual input mode may also be available, which can be used to variably set the setting angle. In order to have good contact with the nozzle plate 8 at different setting angles, the stripper 13 can be attached to the pivot drive 21 in a variable position, for example infinitely variable, in order to move the stripper 13 more or less towards the nozzle plate 8, depending on which setting angle has been selected.

However, it may also be sufficient to use a stripper 13 that is held in a fixed mounting position on the pivot drive 21, whereby a snug fit of the stripper 13 on the nozzle plate 8 can be achieved by pivoting about the swivel axis. In particular, the pivot drive 21 can also be configured or controlled in such a way that no predetermined setting angle is approached, but the stripper 13 is pressed onto the nozzle plate 8 with sufficient force or pivoted in such a way that the stripper 13 is in contact with the nozzle plate 8 with sufficient force. For example, a desired drive force or a desired drive torque can be set to ensure the desired actuating force of the stripper 13 on the nozzle plate 8.

In order to be able to use the stripper 13 in both directions of travel from right to left and from left to right for cleaning the nozzle plate 8, the angle adjustment apparatus 22 is configured to set the setting angle differently or in the opposite direction depending on the direction of travel, preferably in such a way that the leading edge is set at an acute angle and the trailing edge is set at an obtuse angle to the nozzle plate 8.

In order to be able to swivel the stripper 13 back and forth between the different angles of attack, the stripper guide 15 can provide a sufficiently wide range of movement so that the stripper 13 can be moved beyond the nozzle plate 8 and disengaged from it. The stripper 13 can thus be pivoted back and forth in a right end position and in a left end position laterally spaced from the nozzle plate 8.

In order to be able to remove impurities from the stripper 13, a scraper 23 can be provided on at least one side of the nozzle plate 8, which can advantageously be configured with sharp edges, for example in the manner of a blade, along which the stripper 13 can be scraped, in particular by an interaction of the translatory traversing drive and the rotary pivot drive 21, cf. FIGS. 2 to 4, which show the scraper 22 on the left and right side of the nozzle plate 8.

The aforementioned scraper 23 can advantageously be configured so that it can be heated in order to be able to remove plastic impurities from the stripper 13 more easily.

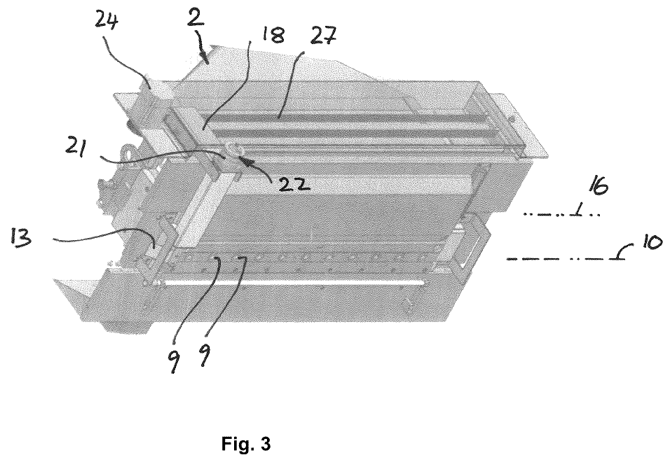

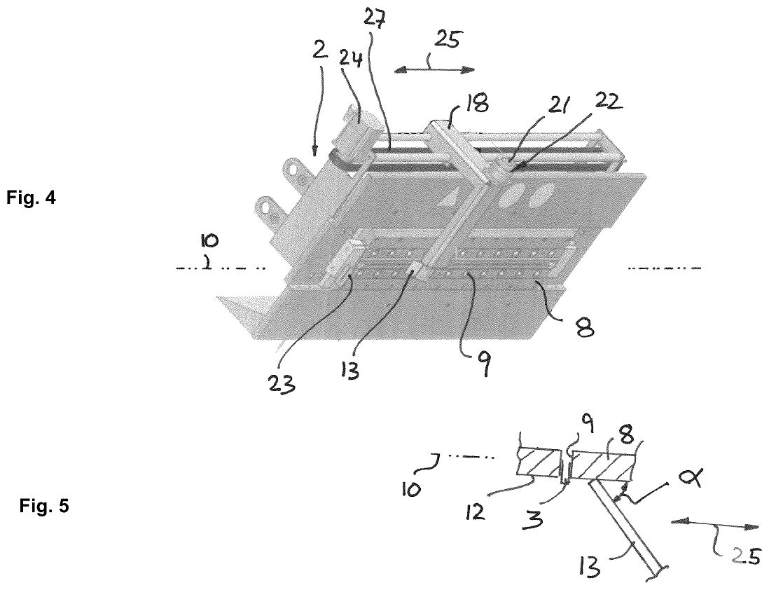

As FIGS. 3 and 4 illustrate, the stripper 13 may initially be parked on one side of the nozzle plate 8, which may be the left side, for example, as shown in FIG. 3. The pivot drive 21 has already swiveled the stripper 13 into its intended swivel position with respect to the rotational axis of movement 17 in order to have the desired setting angle to the nozzle plate 8 for the subsequent stripping process.

If the nozzle plate 8 is to be cleaned or the strands emerging from it are to be separated, the stripper 13 is moved in the transverse direction 10 over the nozzle outlets 9 with the aid of the transverse drive 24, so that the stripper 13 gradually separates the emerging strands and successively scrapes and cleans the nozzle outlets 9.

When the stripper 13 reaches its opposite, in the case of the figures right-hand end position, in which the stripper 13 has moved beyond the nozzle plate 8, the pivot drive 21 can pivot the stripper 13 so that it assumes the desired setting angle again for a subsequent movement from right to left.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An apparatus for feeding strands of plastic material to a strand pelletizer, having a nozzle plate for producing the strands of plastic material, which nozzle plate has a plurality of nozzle outlets distributed in a transverse direction for discharging the strands of plastic material, and a stripper for scraping off the nozzle plate and/or for separating the strands of plastic material discharged from the nozzle plate, wherein the stripper is successively movable in the transverse direction over the plurality of nozzle outlets and can be brought into opposite setting angles by an angle adjustment apparatus for opposite travel movements along the transverse direction.

2. The apparatus of claim 1, wherein the angle adjustment apparatus is configured to provide an acute setting angle to the nozzle plate on the leading edge of the stripper and an obtuse angle to the nozzle plate on the trailing edge of the stripper.

3. The apparatus of claim 2, wherein the setting angle at the leading edge of the stripper towards the nozzle plate is between 15° and 85°.

4. The apparatus of claim 1, wherein the stripper has a straight working edge which lies on the outlet side of the nozzle plate and is aligned perpendicular to the transverse direction.

5. The apparatus of claim 1, wherein the stripper has a working width which is larger than the strand diameter of the strands of plastic material, but smaller than 50% of the extension of the nozzle plate in the transverse direction.

6. An apparatus for feeding strands to a strand pelletizer comprising:
a nozzle plate having nozzle outlets distributed over a transverse length;
an angle adjustment apparatus; and
a stripper configured to:
be movable across the transverse length of the nozzle outlets in successive cycles, each cycle comprising:
moving in a first direction over the transverse length; and
moving in a second direction over the transverse length, the second direction opposite the first direction;
be brought into a first setting angle relative the nozzle plate by the angle adjustment apparatus when moving in the first direction; and
be brought into a second setting angle relative the nozzle plate by the angle adjustment apparatus when moving in the second direction.

7. The apparatus of claim 6, wherein the stripper is further configured to at least one of:
scrape off the nozzle plate; or
separate strands discharged from the nozzle plate.

8. The apparatus of claim 7, wherein:
the stripper has a first edge and a second edge;
the first setting angle is defined by the angle between the first edge of the stripper and the nozzle plate with the stripper moving in the first direction;
the second setting angle is defined by the angle between the second edge of the stripper and the nozzle plate with the stripper moving in the second direction;
the angle adjustment apparatus is configured to set the first setting angle to a first acute angle; and
the angle adjustment apparatus is configured to set the second setting angle to a second acute angle.

9. The apparatus of claim 8, wherein, in a cycle of the successive cycles:
the first acute angle is the same as the second acute angle; or
the first acute angle is different than the second acute angle.

10. The apparatus of claim 8, wherein each of the first and second acute angles is between 15° and 85°.

11. The apparatus of claim 8, wherein each of the first and second acute angles is between 25° to 75°.

12. An apparatus for feeding strands to a strand pelletizer comprising:
a nozzle plate for producing strands of plastic material, the nozzle plate having nozzle outlets distributed over a transverse length of an outlet side of the nozzle plate, the nozzle outlets configured for the discharge of the strands of plastic material;
an angle adjustment apparatus; and
a stripper configured to:
be movable across at least a portion of the nozzle outlets in successive cycles, each cycle comprising moving in a first direction over the transverse length and moving in a second direction over the transverse length, the second direction opposite the first direction;
be brought into a first leading edge setting angle relative the outlet side of the nozzle plate by the angle adjustment apparatus when moving in the first direction; and
be brought into a second leading edge setting angle relative outlet side of the nozzle plate by the angle adjustment apparatus when moving in the second direction;
wherein:
the angle adjustment apparatus is configured to:
set the first leading edge setting angle to a first acute angle between 15° and 85°; and
set the second leading edge setting angle to a second acute angle between 15° and 85°; and
in a respective cycle of the successive cycles:
the first acute angle is the same as the second acute angle; or
the first acute angle is different than the second acute angle.

13. The apparatus of claim 12, wherein the stripper has a straight working edge facing the outlet side of the nozzle plate.

14. The apparatus of claim 12, wherein the stripper has a working width which is larger than a width of the nozzle outlets.

15. The apparatus of claim 12, wherein:
the angle adjustment apparatus comprises a pivot drive for pivoting the stripper about a rotational axis of movement; and
the pivot drive is configured for variable adjustment of a contact force of the stripper against the outlet side of the nozzle plate.

16. The apparatus of claim 12, wherein the stripper is attached to a continuous caster by a stripper guide to which the nozzle plate belongs.

17. The apparatus of claim 12 further comprising a transverse drive for moving the stripper along the transverse length;
wherein the transverse drive comprises a controllable drive motor.

18. The apparatus of claim 12 further comprising a scraper for cleaning the stripper, the scraper provided on at least one side of the nozzle plate.

19. The apparatus of claim 12, wherein the stripper is movable on at least one side of the nozzle plate beyond the nozzle plate and is pivotable by the angle adjustment apparatus between the first and second leading edge setting angles in an end and/or turning position lying next to the nozzle plate.

20. The apparatus of claim 15, wherein:
the pivot drive comprises an electric motor; or
the pivot drive comprises a pressure fluid drive.

21. The apparatus of claim 16, wherein the stripper guide comprises a carriage guide for a carriage carrying the stripper, which carriage guide/carriage is arranged on a continuous caster side of the continuous caster different from the outlet side of the nozzle plate.

22. The apparatus of claim 17, wherein the controllable drive motor is a stepper motor.

23. The apparatus of claim 17, wherein the transverse drive has a belt stage that is arranged on a side facing away from the outlet side of the nozzle plate.

24. The apparatus of claim 18, wherein the scraper is stationary and the stripper is configured to be scraped over the scraper by a controlled movement of a transverse drive for moving the stripper along the transverse length and/or a pivot drive of the angle adjustment apparatus, the pivot drive for pivoting the stripper about a rotational axis of movement.

25. The apparatus of claim 21, wherein:
the stripper is further configured to at least one of:
scrape off the nozzle plate; or
separate the strands of plastic material discharged from the nozzle outlets;
the apparatus further comprises a sloping drainage trough positioned below the nozzle plate for conveying strands of plastic material away from the nozzle plate towards the strand pelletizer; and
the carriage guide and/or the carriage is arranged on a caster side facing away from and/or facing upwards from the sloping drainage trough.

26. The apparatus of claim 21, wherein the angle adjustment apparatus is mounted on the carriage of the stripper guide and extends from the carriage over the outlet side of the nozzle plate.

27. A strand pelletizing installation comprising
a strand pelletizer for pelletizing plastic strands into pellets; and
the apparatus of claim 12 for feeding the strands of plastic material to the strand pelletizer.
